(19) United States
(12) Patent Application Publication
(10) Pub. No.: US 2026/0202217 A1
(43) Pub. Date: Jul. 16, 2026

(54) Method for mouse event interaction based on general gyroscope and electronic device

(71) Applicant: HOOROO NETWORK PTE. LTD., Singapore (SG)

(72) Inventors: Li Ma, Shenzhen (CN); Sheng Pang, Beiliu City (CN)

(21) Appl. No.: 19/023,708

(22) Filed: Jan. 16, 2025

(51) Int. Cl. G01C 25/00; G01C 19/00; G06F 3/0346; G06F 3/0354

(52) U.S. Cl. CPC G01C 25/00; G06F 3/0346; G06F 3/03543; G01C 19/00

(57) ABSTRACT

The present invention discloses a method, system, and device for mouse event interaction based on a general gyroscope, belonging to the technical field of mouse event interaction. The method includes the following steps: monitoring the output data of the gyroscope in a stationary state, and processing the output data of the gyroscope in a stationary state to obtain an evaluation value of the static offset degree of the gyroscope; collecting the output data of the gyroscope, and performing initial data calibration on the output data of the gyroscope according to the evaluation value of the static offset degree of the gyroscope; monitoring the working environment data and the working state data of the gyroscope, comprehensively analyzing the working environment data, the working state data, and the evaluation value of the static offset degree of the gyroscope to obtain an evaluation value of the dynamic offset degree of the gyroscope.

### TECHNICAL FIELD

The present invention relates to the technical field of mouse event interaction, and more particularly to a method, system, and device for mouse event interaction based on a general gyroscope.

### BACKGROUND

With the continuous development of sensor technology and the field of human-computer interaction, traditional two-dimensional input methods can no longer meet people's growing demand for natural input. The advancement of sensor technology has enabled new sensors such as gyroscopes to be widely used in human-computer interaction, providing users with a more intuitive and free input method.

Existing mouse event interaction methods based on general gyroscopes mainly capture users' gesture movements through the gyroscope sensor integrated in the device. By using the gyroscope's ability to detect angular velocity, when the user moves the handheld device in the air or in a specific space, the gyroscope can sense slight rotational changes and convert these changes into cursor movements or click operations on the screen through algorithms.

For example, the invention patent with the publication number CN102520795B discloses a gyroscope-based human-computer interaction detection and processing method on a smart terminal, including: (1) establishing a three-dimensional coordinate system on the smart terminal, with the X-axis direction being horizontal from left to right, the Y-axis direction being vertical from bottom to top, and the Z-axis direction being perpendicular to the smart terminal screen from back to front; (2) if the holder of the smart terminal makes an action on the smart terminal, testing the angular rate of the terminal device rotating around the X-axis, the angular rate of rotating around the Y-axis, and the angular rate of rotating around the Z-axis through the gyroscope; (3) obtaining the change curves of the angular rates of rotating around the X-axis, Y-axis, and Z-axis with respect to time through sampling the angular rates; (4) judging the action made by the smart terminal according to the waveform diagrams on the change curves of the angular rates of the X-axis, Y-axis, and Z-axis, and triggering the corresponding event according to the setting.

Another example is the invention patent with the publication number CN105068664B, which discloses an interaction system and an interaction control method. The interaction control device includes a gyroscope, a main control circuit board, and a wireless communication module. The interaction processing device is arranged in the user equipment. The interaction control device sends sensing information to the interaction processing device through the wireless communication module. The sensing information includes acceleration sensing information, which is generated by the main control circuit board according to the acceleration sensing signal generated by the gyroscope sensing the movement of the interaction control device. The interaction processing device generates an operation instruction for controlling the user equipment according to the sensing information and controls the user equipment according to the operation instruction.

However, in the process of implementing the technical solution of the present invention, it is found that the above-mentioned technologies have at least the following technical problems:

In the prior art, due to the interference such as zero drift and noise in the acquisition of gyroscope data, the accuracy of gyroscope data is low. Therefore, when using these gyroscope data to simulate mouse operations, there are problems of varying degrees of stuttering and drift.

### SUMMARY

The present invention provides a method, system, and device for mouse event interaction based on a general gyroscope, which solves the problem in the prior art that the accuracy of gyroscope data is low due to the interference such as zero drift and noise in the acquisition of gyroscope data, resulting in problems of varying degrees of stuttering and drift when using these gyroscope data to simulate mouse operations, and realizes the improvement of the accuracy of gyroscope data.

The present invention provides a method for mouse event interaction based on a general gyroscope, including the following steps: monitoring the output data of the gyroscope in a stationary state, and processing the output data of the gyroscope in a stationary state to obtain an evaluation value of the static offset degree of the gyroscope; collecting the output data of the gyroscope, and performing initial data calibration on the output data of the gyroscope according to the evaluation value of the static offset degree of the gyroscope; monitoring the working environment data and the working state data of the gyroscope, comprehensively analyzing the working environment data, the working state data, and the evaluation value of the static offset degree of the gyroscope to obtain an evaluation value of the dynamic offset degree of the gyroscope, and judging whether to perform secondary data calibration according to the evaluation value of the dynamic offset degree of the gyroscope; simulating a mouse event according to the output data of the gyroscope after data calibration is completed.

Further, the step of processing the output data of the gyroscope in a stationary state to obtain an evaluation value of the static offset degree of the gyroscope includes: the output data of the gyroscope in a stationary state includes the angular velocity and angular acceleration around the X, Y, and Z axes, where the angular velocity includes the angular velocity offset value and the angular velocity fluctuation degree value; obtaining the critical angular velocity offset value, the critical angular velocity fluctuation degree value, the reference angular acceleration, and the allowable deviation angular acceleration from the mouse interaction database; comprehensively analyzing to obtain the evaluation value of the static offset degree of the gyroscope.

Further, the step of performing initial data calibration on the output data of the gyroscope according to the evaluation value of the static offset degree of the gyroscope includes: obtaining the first evaluation threshold of the static offset degree of the gyroscope and the second evaluation threshold of the static offset degree of the gyroscope from the mouse event database; comparing the evaluation value of the static offset degree of the gyroscope with the first evaluation threshold of the static offset degree of the gyroscope and the second evaluation threshold of the static offset degree of the gyroscope respectively. If the evaluation value of the static offset degree of the gyroscope is less than or equal to the first evaluation threshold of the static offset degree of the gyroscope, the gyroscope is marked as a low-offset gyroscope. If the evaluation value of the static offset degree of the gyroscope is greater than the first evaluation threshold of the static offset degree of the gyroscope and less than or equal to the second evaluation threshold of the static offset degree of the gyroscope, the gyroscope is marked as a medium-offset gyroscope. If the evaluation value of the static offset degree of the gyroscope is greater than the second evaluation threshold of the static offset degree of the gyroscope, the gyroscope is marked as a high-offset gyroscope; performing initial data calibration on the output data of the gyroscope according to the output data correction value corresponding to the gyroscope offset level preset in the mouse event database.

Further, the step of comprehensively analyzing the working environment data, the working state data, and the evaluation value of the static offset degree of the gyroscope to obtain an evaluation value of the dynamic offset degree of the gyroscope includes: comprehensively analyzing the working environment data of the gyroscope to obtain an environmental abnormality evaluation value; comprehensively analyzing the working state data of the gyroscope to obtain a working state evaluation value; obtaining the critical environmental abnormality evaluation value, the critical working state evaluation value, and the critical evaluation value of the static offset degree of the gyroscope from the mouse event database; comprehensively analyzing to obtain the evaluation value of the dynamic offset degree of the gyroscope.

Further, the step of comprehensively analyzing the working environment data of the gyroscope to obtain an environmental abnormality evaluation value includes: the working environment data of the gyroscope includes the temperature at each time monitoring point, the temperature change rate at each time monitoring point, and the maximum temperature difference; obtaining the reference temperature, the allowable deviation temperature, the critical temperature change rate, and the critical maximum temperature difference from the mouse event database; comprehensively analyzing to obtain the environmental abnormality evaluation value.

Further, the step of comprehensively analyzing the working state data of the gyroscope to obtain a working state evaluation value includes: the working state data of the gyroscope includes the cumulative usage time, the voltage fluctuation degree value, and the vibration frequency; obtaining the critical cumulative usage time, the critical voltage fluctuation degree value, the reference vibration frequency, and the allowable deviation vibration frequency from the mouse event database; comprehensively analyzing to obtain the working state evaluation value.

Further, the evaluation value of the dynamic offset degree of the gyroscope is obtained as follows:

$$ξ {I}_{1} = {( \frac{1}{e} )}^{arccot \{ {α}_{7} * [ 1 + {( \frac{ξ {T}_{1}}{ξ {T}_{0}} )}^{2} ] + {α}_{9} * ln ( \frac{ξ {O}_{1}}{ξ {O}_{0}} + 1 ) \}} + {α}_{8} * {log}_{2} ( \frac{ξ {S}_{0}}{ξ {S}_{1}} + 1 ) ;$$

where represents the evaluation value of the dynamic offset degree of the gyroscope, represents the influence factor of the environmental abnormality evaluation value on the evaluation value of the dynamic offset degree of the gyroscope, represents the influence factor of the working state evaluation value on the evaluation value of the dynamic offset degree of the gyroscope, represents the influence factor of the evaluation value of the static offset degree of the gyroscope on the evaluation value of the dynamic offset degree of the gyroscope, represents the environmental abnormality evaluation value, represents the critical environmental abnormality evaluation value, represents the working state evaluation value, represents the critical working state evaluation value, represents the evaluation value of the static offset degree of the gyroscope, and represents the critical evaluation value of the static offset degree of the gyroscope.

Further, the step of judging whether to perform secondary data calibration according to the evaluation value of the dynamic offset degree of the gyroscope includes: obtaining the evaluation threshold of the dynamic offset degree of the gyroscope from the mouse event database; comparing the evaluation value of the dynamic offset degree of the gyroscope with the evaluation threshold of the dynamic offset degree of the gyroscope. If the evaluation value of the dynamic offset degree of the gyroscope is less than or equal to the evaluation threshold of the dynamic offset degree of the gyroscope, secondary data calibration is not performed. If the evaluation value of the dynamic offset degree of the gyroscope is greater than the evaluation threshold of the dynamic offset degree of the gyroscope, secondary data calibration is performed.

The present application embodiment provides a system for mouse event interaction based on a general gyroscope, characterized in that it includes an initial calibration module, a secondary calibration module, an event interaction module, and a mouse event database; wherein the initial calibration module is used to monitor the output data of the gyroscope in a stationary state, process the output data of the gyroscope in a stationary state to obtain an evaluation value of the static offset degree of the gyroscope, collect the output data of the gyroscope, and perform initial data calibration on the output data of the gyroscope according to the evaluation value of the static offset degree of the gyroscope; the secondary calibration module is used to monitor the working environment data and the working state data of the gyroscope, comprehensively analyze the working environment data, the working state data, and the evaluation value of the static offset degree of the gyroscope to obtain an evaluation value of the dynamic offset degree of the gyroscope, and judge whether to perform secondary data calibration according to the evaluation value of the dynamic offset degree of the gyroscope; the event interaction module is used to simulate a mouse event according to the output data of the gyroscope after data calibration is completed.

The present application embodiment provides an electronic device for mouse event interaction based on a general gyroscope, including: a processor, and a memory for storing the executable instructions of the processor; the processor is configured to execute the instructions to enable the electronic device to implement the method for mouse event interaction based on a general gyroscope according to any one of claims 1-8.

The one or more technical solutions provided in the embodiments of the present application have at least the following technical effects or advantages:

The present invention provides a method, system, and device for mouse event interaction based on a general gyroscope, thereby accurately evaluating the static offset of the gyroscope and analyzing the dynamic offset in combination with the working environment and working state data, and further realizing high-precision calibration and correction of gyroscope data under various environmental conditions.

The present invention performs initial data calibration on the output data of the gyroscope according to the evaluation value of the static offset degree of the gyroscope, thereby eliminating the initial error caused by the static offset, and further realizing more accurate output of gyroscope data, providing a reliable data basis for subsequent dynamic calibration and mouse event simulation, and improving the stability and interaction accuracy of the system.

The present invention judges whether to perform secondary data calibration according to the evaluation value of the dynamic offset degree of the gyroscope, thereby adjusting and compensating the dynamic offset caused by environmental changes or working state changes in real time during the operation of the gyroscope, and further realizing the continuous accuracy and stability of the output data of the gyroscope, ensuring the accuracy and reliability of mouse event simulation.

### DESCRIPTION OF DRAWINGS

To illustrate the technical solutions of the embodiments of the present disclosure more clearly, the following briefly introduces the accompanying drawings that need to be used in the embodiments. It should be understood that the following drawings only show some embodiments of the present disclosure and therefore should not be regarded as limiting the scope. For those of ordinary skill in the art, other relevant drawings can be obtained according to these drawings without creative efforts.

### DESCRIPTION OF EMBODIMENTS

The embodiments of the present application solve the problem in the prior art that the accuracy of gyroscope data is low due to the interference such as zero drift and noise in the acquisition of gyroscope data, resulting in problems of varying degrees of stuttering and drift when using these gyroscope data to simulate mouse operations, by monitoring the output data of the gyroscope in a stationary state, processing the output data of the gyroscope in a stationary state to obtain an evaluation value of the static offset degree of the gyroscope, collecting the output data of the gyroscope, performing initial data calibration on the output data of the gyroscope according to the evaluation value of the static offset degree of the gyroscope, monitoring the working environment data and the working state data of the gyroscope, comprehensively analyzing the working environment data, the working state data, and the evaluation value of the static offset degree of the gyroscope to obtain an evaluation value of the dynamic offset degree of the gyroscope, judging whether to perform secondary data calibration according to the evaluation value of the dynamic offset degree of the gyroscope, and simulating a mouse event according to the output data of the gyroscope after data calibration is completed, thereby realizing the improvement of the accuracy of gyroscope data.

The overall idea of the technical solution in the embodiments of the present application to solve the above problems caused by the interference such as zero drift and noise in the acquisition of gyroscope data, resulting in low accuracy of gyroscope data and problems of varying degrees of stuttering and drift when using these gyroscope data to simulate mouse operations is as follows:

By monitoring the output data of the gyroscope in a stationary state, processing the output data of the gyroscope in a stationary state to obtain an evaluation value of the static offset degree of the gyroscope, collecting the output data of the gyroscope, performing initial data calibration on the output data of the gyroscope according to the evaluation value of the static offset degree of the gyroscope, monitoring the working environment data and the working state data of the gyroscope, comprehensively analyzing the working environment data, the working state data, and the evaluation value of the static offset degree of the gyroscope to obtain an evaluation value of the dynamic offset degree of the gyroscope, judging whether to perform secondary data calibration according to the evaluation value of the dynamic offset degree of the gyroscope, and simulating a mouse event according to the output data of the gyroscope after data calibration is completed, the reliability of mouse event simulation is improved.

In order to better understand the above technical solution, the following will describe the above technical solution in detail with reference to the accompanying drawings and specific embodiments.

It is a flowchart of a method for mouse event interaction based on a general gyroscope provided in an embodiment of the present application. The method includes the following steps: monitoring the output data of the gyroscope in a stationary state, and processing the output data of the gyroscope in a stationary state to obtain an evaluation value of the static offset degree of the gyroscope; collecting the output data of the gyroscope, and performing initial data calibration on the output data of the gyroscope according to the evaluation value of the static offset degree of the gyroscope; monitoring the working environment data and the working state data of the gyroscope, comprehensively analyzing the working environment data, the working state data, and the evaluation value of the static offset degree of the gyroscope to obtain an evaluation value of the dynamic offset degree of the gyroscope, and judging whether to perform secondary data calibration according to the evaluation value of the dynamic offset degree of the gyroscope; simulating a mouse event according to the output data of the gyroscope after data calibration is completed.

In this embodiment, the evaluation value of the static offset degree helps to identify the inherent error of the gyroscope in a stationary state, which is the first step to improve the data accuracy. The initial data calibration based on the static offset degree can reduce or eliminate this inherent error, thereby improving the initial accuracy of the data. Monitoring the working environment and working state of the gyroscope and combining the evaluation value of the static offset degree can dynamically evaluate the offset situation of the gyroscope. Performing secondary data calibration according to the evaluation value of the dynamic offset degree can further reduce the error of the data in a dynamic environment and improve the overall stability of the system. The present invention not only improves the accuracy and stability of gyroscope data but also provides users with a more smooth and accurate interaction experience and helps to improve the overall performance of the device and reduce maintenance costs.

The present invention requires the installation of a specially developed application program, which is responsible for Bluetooth connection with the general gyroscope device, data reception and processing, and simulating mouse events and transmitting them to the mobile phone operating system. The application program has a graphical user interface to facilitate users to perform device connection settings, operation mode selection, sensitivity adjustment, and other operations. After the secondary calibration is completed, the general gyroscope device collects motion data at a set frequency (such as 100 Hz) and sends the data to the mobile phone application through the Bluetooth module. The data transmission adopts an optimized Bluetooth transmission protocol, performs packet segmentation on the data, and adds a check bit to ensure that the data is transmitted to the mobile phone intact. After the mobile phone application receives the data, it first performs data unpacking and verification. If the data is correct, it enters the processing flow. Here, a dynamic data mapping algorithm is adopted to convert the three-dimensional motion data of the gyroscope into the corresponding mouse event. For example, the positive rotation around the X-axis is mapped to the upward movement of the mouse, and the positive rotation around the Y-axis is mapped to the leftward movement of the mouse. By setting thresholds and sensitivity parameters, the speed and distance of the mouse movement are determined according to the rotation angle and angular velocity. For events, for example, a specific wrist shaking action can be mapped to the pressing of the space bar. At the same time, in order to avoid misoperations, an action filtering mechanism is added to the algorithm. Only when the action meets the specified pattern and duration requirements will the corresponding event be triggered. For example, for the mouse simulation function, according to the mouse movement event obtained by data processing, the mobile phone application program calls the underlying interface of the mobile phone operating system to generate a mouse movement instruction to control the movement of the cursor on the mobile phone screen. For mouse click events, such as detecting the quick tapping action or specific rotation combination action of the gyroscope device, the mobile phone application sends a left-click, right-click, or middle-click instruction of the mouse to the operating system to realize operations such as clicking icons, selecting text, and opening menus. The framework diagram of the method for mouse event interaction based on a general gyroscope.

In addition, the mouse interaction database is used to store the relevant data of the method for mouse event interaction based on a general gyroscope, including: the critical angular velocity offset value, the critical angular velocity fluctuation degree value, the influence factor of the angular velocity offset value on the evaluation value of the static offset degree of the gyroscope, the output data correction value corresponding to the gyroscope offset level, and the first evaluation threshold of the static offset degree of the gyroscope. The data in the mouse interaction database can be directly queried from public databases such as Kaggle and UCI Machine Learning Repository, or obtained through data sharing with gyroscope sensor manufacturers or device manufacturers.

Further, the step of processing the output data of the gyroscope in a stationary state to obtain an evaluation value of the static offset degree of the gyroscope includes: the output data of the gyroscope in a stationary state includes the angular velocity and angular acceleration around the X, Y, and Z axes, where the angular velocity includes the angular velocity offset value and the angular velocity fluctuation degree value; obtaining the critical angular velocity offset value, the critical angular velocity fluctuation degree value, the reference angular acceleration, and the allowable deviation angular acceleration from the mouse interaction database; comprehensively analyzing to obtain the evaluation value of the static offset degree of the gyroscope.

The evaluation value of the static offset degree of the gyroscope is obtained as follows:

$$ξ {O}_{1} = arc cot ( {β}_{1} * \frac{{F}_{2}}{\vert {F}_{1} - {F}_{0} \vert + 1} + {β}_{2} * ln ( \frac{{D}_{0}}{{D}_{1}} 1 + ) ) + {( {β}_{3} * \frac{\vert {A}_{1} - {A}_{0} \vert}{{A}_{2}} + 1 )}^{- 1} ;$$

where ξO₁ represents the evaluation value of the static offset degree of the gyroscope, β₁ represents the influence factor of the angular velocity offset value on the evaluation value of the static offset degree of the gyroscope, β₂ represents the influence factor of the angular velocity fluctuation degree value on the evaluation value of the static offset degree of the gyroscope, β₃ represents the influence factor of the angular acceleration on the evaluation value of the static offset degree of the gyroscope, F₁ represents the output angular velocity at the start time point of the monitoring period, F₀ represents the output angular velocity at the end time point of the monitoring period, F₂ represents the critical angular velocity offset value, D₁ represents the angular velocity fluctuation degree value, D₀ represents the critical angular velocity fluctuation degree value, A₁ represents the angular acceleration, A₀ represents the reference angular acceleration, and A₂ represents the allowable deviation angular acceleration.

β₁, β₂, β₃ and are the preset influence factors of the angular velocity offset value, the angular velocity fluctuation degree value, and the angular acceleration on the evaluation value of the static offset degree of the gyroscope in the mouse interaction database, respectively. These influence factors are numerical indicators that measure the influence of the above parameters on the evaluation value of the static offset degree of the gyroscope. Specifically, the angular velocity offset value, the angular velocity fluctuation degree value, and the angular acceleration each have a mapping relationship table, which records the corresponding influence factor of each possible parameter value on the evaluation value of the static offset degree of the gyroscope. These mapping relationships can be one-to-one or many-to-one. In practical applications, when evaluating the static offset degree of the gyroscope, the measured angular velocity offset value, angular velocity fluctuation degree value, and angular acceleration can be input into their corresponding mapping relationship tables respectively to quickly find the corresponding influence factors of these values on the evaluation value of the static offset degree of the gyroscope. The value range of the influence factor is between 0 and 1.

In this embodiment, the angular velocity offset value and the angular velocity fluctuation degree value are the mean values of the gyroscope angular velocity offset values and angular velocity fluctuation degree values around the X, Y, and Z axes, respectively, and the angular acceleration is the mean value of the gyroscope angular accelerations around the X, Y, and Z axes. In addition, the present invention is equipped with a built-in gyroscope sensor at the gyroscope device end, which can collect the motion data of the device in real time, including the angular velocity and angular acceleration around the X, Y, and Z axes. At the same time, it is equipped with a Bluetooth module for transmitting the collected gyroscope data to the mobile phone application program.

The angular velocity offset value refers to the deviation of the angular velocity signal output by the gyroscope in a stationary state. The absolute value of the difference between the output angular velocity at the start time point and the end time point of the monitoring period can be marked as the angular velocity offset value by using a data recorder or a dedicated sensor interface to continuously record the angular velocity output of the gyroscope. The angular velocity fluctuation degree value is the standard deviation of the gyroscope angular velocity within one fluctuation cycle. The angular velocity fluctuation degree value is obtained as follows:

$${D}_{1} = \sqrt{\frac{1}{{F}_{1}} {\sum }_{f = 1}^{{F}_{1}} {( {x}_{f} - \overline{x} )}^{2}} ,$$

where D₁ represents the angular velocity fluctuation degree value, x_{f} represents the angular velocity at the f-th time monitoring point, x̅ represents the mean value of the angular velocity within one fluctuation cycle, and

$$\overline{x} = \frac{1}{{F}_{1}} {\sum }_{f = 1}^{{F}_{1}} {x}_{f} ,$$

where f is the number of each time monitoring point, f=1, 2, 3, . . . F₁, and F₁ is the duration of one fluctuation cycle. The angular acceleration can be directly measured by the internal micro-electromechanical system accelerometer sensor of the gyroscope. In an ideal stationary state, the reference angular velocity offset value, the reference angular velocity fluctuation degree value, and the reference angular acceleration are all 0. The three are interrelated. For example, the angular velocity offset value represents the zero drift of the gyroscope, and the angular velocity fluctuation degree value indicates the stability of the gyroscope at rest. The two jointly affect the accuracy of the gyroscope, and the angular acceleration is directly related to the fluctuation degree and offset value of the angular velocity. A larger angular velocity offset or fluctuation will lead to a larger angular acceleration fluctuation. The comprehensively analyzed evaluation value of the static offset degree of the gyroscope can more accurately understand the offset degree and performance of the gyroscope in a static condition and provide strong support for subsequent error analysis and performance optimization.

Further, the step of performing initial data calibration on the output data of the gyroscope according to the evaluation value of the static offset degree of the gyroscope includes: obtaining the first evaluation threshold of the static offset degree of the gyroscope and the second evaluation threshold of the static offset degree of the gyroscope from the mouse event database; comparing the evaluation value of the static offset degree of the gyroscope with the first evaluation threshold of the static offset degree of the gyroscope and the second evaluation threshold of the static offset degree of the gyroscope respectively. If the evaluation value of the static offset degree of the gyroscope is less than or equal to the first evaluation threshold of the static offset degree of the gyroscope, the gyroscope is marked as a low-offset gyroscope, indicating that the static offset of the gyroscope is very small, that is, the deviation between the measured angle or rotation speed and the actual situation is within an acceptable range, and the error has little impact on the device. The output data correction value corresponding to the low-offset gyroscope preset in the mouse event database can be directly used for calibration. If the evaluation value of the static offset degree of the gyroscope is greater than the first evaluation threshold of the static offset degree of the gyroscope and less than or equal to the second evaluation threshold of the static offset degree of the gyroscope, the gyroscope is marked as a medium-offset gyroscope, indicating that the static offset of the gyroscope has a certain degree of deviation and there may be some errors. Especially in the case of long-term use or a changing environment, the error will increase slightly. The output data correction value can be used for adjustment while combining the accelerometer data for joint calibration to reduce the offset error. If necessary, a filtering algorithm (such as the Kalman filter) can be used to smooth the data and further eliminate the influence of the static offset. If the evaluation value of the static offset degree of the gyroscope is greater than the second evaluation threshold of the static offset degree of the gyroscope, the gyroscope is marked as a high-offset gyroscope, indicating that the static offset of the gyroscope is large and the deviation between the measurement result and the actual situation is significant. This will affect the accuracy of the device and may even lead to serious error accumulation and affect the effectiveness of subsequent data. The offset value can be recalculated, combined with multiple measurements and working in conjunction with other sensors (such as accelerometers and magnetometers) for large-scale correction. The output data of the gyroscope is calibrated according to the output data correction value corresponding to the gyroscope offset level preset in the mouse event database.

In this embodiment, by setting thresholds, the offset degree of the gyroscope can be accurately classified, and different correction measures can be taken for gyroscopes with different offset degrees. The initial data calibration is based on the preset correction values, which are obtained from a large amount of mouse event data. Therefore, the accuracy of the gyroscope output data can be significantly improved. By setting multiple thresholds, the offset degree of the gyroscope can be accurately divided into different levels, which helps to take different processing measures for gyroscopes with different offset degrees and improves the pertinence and effectiveness of calibration.

Further, the step of comprehensively analyzing the working environment data, the working state data, and the evaluation value of the static offset degree of the gyroscope to obtain an evaluation value of the dynamic offset degree of the gyroscope includes: comprehensively analyzing the working environment data of the gyroscope to obtain an environmental abnormality evaluation value; comprehensively analyzing the working state data of the gyroscope to obtain a working state evaluation value; obtaining the critical environmental abnormality evaluation value, the critical working state evaluation value, and the critical evaluation value of the static offset degree of the gyroscope from the mouse event database; comprehensively analyzing to obtain the evaluation value of the dynamic offset degree of the gyroscope.

In this embodiment, by comprehensively considering multiple factors such as the working environment, working state, and static offset degree of the gyroscope, the dynamic offset degree of the gyroscope can be more accurately evaluated, and more accurate calibration can be performed. Timely calibration and adjustment can ensure that the gyroscope can maintain stable performance under different environments and working states and reduce errors caused by offset.

Further, the step of comprehensively analyzing the working environment data of the gyroscope to obtain an environmental abnormality evaluation value includes: the working environment data of the gyroscope includes the temperature at each time monitoring point, the temperature change rate at each time monitoring point, and the maximum temperature difference; obtaining the reference temperature, the allowable deviation temperature, the critical temperature change rate, and the critical maximum temperature difference from the mouse event database; comprehensively analyzing to obtain the environmental abnormality evaluation value.

The environmental abnormality evaluation value is obtained as follows:

$$ξ {T}_{1} = {\sum }_{i = 1}^{N} {e}^{sinh ( {α}_{1} * \sqrt{\frac{\vert {T}_{1} i - {T}_{0} \vert}{{T}_{2}} + {α}_{2} * ln ( \frac{{R}_{1} i}{{R}_{0}} + 1 )} )} + {α}_{3} * tanh ( \frac{{max}_{1 \leq i \leq N} ( {T}_{1 i} ) - {min}_{1 \leq i \leq N} ( {T}_{1 i} )}{{D}_{0}} )$$

where ξT₁ represents the environmental abnormality evaluation value, α₁ represents the influence factor of the temperature on the environmental abnormality evaluation value, α₂ represents the influence factor of the temperature change rate on the environmental abnormality evaluation value, α₃ represents the influence factor of the maximum temperature difference on the environmental abnormality evaluation value, T₁ᵢ represents the temperature at the i-th time monitoring point, T₀ represents the reference temperature, T₂ represents the allowable deviation temperature, R₁ᵢ represents the temperature change rate at the i-th time monitoring point, R₀ represents the critical temperature change rate,

$${max}_{1 \leq i \leq N} ( {T}_{1 i} )$$

represents the maximum temperature among the time monitoring points,

$${min}_{1 \leq i \leq N} ( {T}_{1 i} )$$

represents the minimum temperature among the time monitoring points, and D₀ represents the critical maximum temperature difference. e is the natural constant, where i is the number of each time monitoring point, i=1, 2, 3, . . . , N, and N is the total number of time monitoring points.

α₁, α₂, α₃ and are the preset influence factors of the temperature, the temperature change rate, and the maximum temperature difference on the environmental abnormality evaluation value in the mouse interaction database, respectively. These influence factors are numerical indicators that measure the influence of the above parameters on the environmental abnormality evaluation value. Specifically, the temperature, the temperature change rate, and the maximum temperature difference each have a mapping relationship table, which records the corresponding influence factor of each possible parameter value on the environmental abnormality evaluation value. These mapping relationships can be one-to-one or many-to-one. In practical applications, when evaluating the environmental abnormality of the gyroscope, the measured temperature, temperature change rate, and maximum temperature difference can be input into their corresponding mapping relationship tables respectively to quickly find the corresponding influence factors of these values on the environmental abnormality evaluation value. The value range of the influence factor is between 0 and 1.

In this embodiment, the temperature at each time monitoring point can be directly measured by installing a temperature sensor at each monitoring point of the gyroscope. The temperature change rate at each time monitoring point can be obtained by continuously monitoring the temperature at multiple time points, calculating the temperature difference between adjacent time points, and dividing by the time difference. The temperature, the temperature change rate, and the maximum temperature difference are interrelated. For example, in a high-temperature environment, the temperature change will be more [symbol] (such as rapid heating or cooling), resulting in a larger temperature difference in the same time. In a low-temperature environment, the change rate is slower, and the temperature difference in the same time is smaller. The comprehensively analyzed environmental abnormality evaluation value can accurately evaluate the environmental abnormality of the gyroscope's working environment, discover potential problem areas, and provide strong support for optimizing the working environment. When the environmental abnormality evaluation value is greater than or equal to the preset environmental abnormality evaluation threshold in the mouse event database, the system will automatically turn on the heat dissipation function. For example, quickly start a heat dissipation back clip or heat sink and other heat dissipation devices for effective heat dissipation, or turn on the internal or external fan of the gyroscope to force air flow to take away the heat generated by the device and reduce the temperature until the environmental abnormality evaluation value is lower than the environmental abnormality evaluation threshold.

Further, the step of comprehensively analyzing the working state data of the gyroscope to obtain a working state evaluation value includes: the working state data of the gyroscope includes the cumulative usage time, the voltage fluctuation degree value, and the vibration frequency; obtaining the critical cumulative usage time, the critical voltage fluctuation degree value, the reference vibration frequency, and the allowable deviation vibration frequency from the mouse event database; comprehensively analyzing to obtain the working state evaluation value. The working state evaluation value is obtained as follows:

$$ξ {S}_{1} = tanh [ {( \frac{1}{e} )}^{\sqrt{{α}_{4} * ln ( \frac{{U}_{1}}{{U}_{0}} + 1 ) + {α}_{5} * {( \frac{{V}_{1}}{{V}_{0}} )}^{2}}} + {α}_{6} * \frac{{C}_{2}}{\vert {C}_{1} - {C}_{0} \vert + 1} ]$$

where ξS₁ represents the working state evaluation value, α₄ represents the influence factor of the cumulative usage time on the working state evaluation value, α₅ represents the influence factor of the voltage fluctuation degree value on the working state evaluation value, α₆ represents the influence factor of the vibration frequency on the working state evaluation value, U₁ represents the cumulative usage time, V₁ represents the critical cumulative usage time, V₀ represents the voltage fluctuation degree value, C₁ represents the critical voltage fluctuation degree value, C₀ represents the vibration frequency, C₂ represents the reference vibration frequency, and represents the allowable deviation vibration frequency.

α₄, α₅, α₆ and are the preset influence factors of the cumulative usage time, the voltage fluctuation degree value, and the vibration frequency on the working state evaluation value in the mouse interaction database, respectively. These influence factors are numerical indicators that measure the influence of the above parameters on the working state evaluation value. Specifically, the cumulative usage time, the voltage fluctuation degree value, and the vibration frequency each have a mapping relationship table, which records the corresponding influence factor of each possible parameter value on the working state evaluation value. These mapping relationships can be one-to-one or many-to-one. In practical applications, when evaluating the working state of the gyroscope, the measured cumulative usage time, voltage fluctuation degree value, and vibration frequency can be input into their corresponding mapping relationship tables respectively to quickly find the corresponding influence factors of these values on the working state evaluation value. The value range of the influence factor is between 0 and 1.

In this embodiment, the cumulative usage time can be obtained by recording the startup and shutdown times of the gyroscope each time and then accumulating the time periods. The voltage fluctuation degree value refers to the fluctuation of the power supply voltage during the operation of the gyroscope. The voltage value during the operation of the gyroscope can be monitored in real time by a voltage sensor or a price voltage monitor. The difference between the maximum voltage value and the minimum voltage value during the operation of the gyroscope is the voltage fluctuation degree value. The vibration frequency can be measured by a vibration frequency meter or a related sensor. The three are interrelated. For example, with the increase of the usage time, the aging of the gyroscope may lead to a decrease in the tolerance of the internal circuit to voltage fluctuations, thereby increasing the impact of voltage fluctuations on the performance of the device. Voltage instability may cause fluctuations in the sensor performance of the gyroscope, thereby affecting the measurement of the vibration frequency. Over time, the gyroscope may experience slight changes in its internal structure due to long-term operation, increasing its sensitivity to external vibrations. The comprehensively analyzed working state evaluation influence factor can evaluate the overall working state and performance level of the gyroscope. Based on this evaluation value, targeted maintenance and management of the gyroscope can be carried out to ensure its continuous and stable operation.

Set the influence factor of the cumulative usage time on the working state evaluation value to 0.2, the influence factor of the voltage fluctuation degree value on the working state evaluation value to 0.4, the influence factor of the vibration frequency on the working state evaluation value to 0.4, the cumulative usage time to 300 h, the critical cumulative usage time to 360 h, the voltage fluctuation degree value to 5V, the critical voltage fluctuation degree value to 4V, the reference vibration frequency to 10 Hz, and the allowable deviation vibration frequency to 2 Hz. Calculate the working state evaluation value when the vibration frequency continuously increases. As shown in Table 1, the data table of the working state evaluation value of the method for mouse event interaction based on a general gyroscope.

TABLE 1
Data Table of the Working State Evaluation Value of the Method
for Mouse Event Interaction Based on a General Gyroscope

| Number | C₁ | ξS₁ |
|---|---|---|
| 1 | 6 | 0.524 |
| 2 | 8 | 0.597 |
| 3 | 10 | 0.840 |
| 4 | 12 | 0.597 |
| 5 | 14 | 0.524 |

It is a graph of the change of the working state evaluation value of the method for mouse event interaction based on a general gyroscope provided in an embodiment of the present application. As shown in Table 1, it can be seen that when the influence factor of the cumulative usage time on the working state evaluation value, the influence factor of the voltage fluctuation degree value on the working state evaluation value, the influence factor of the vibration frequency on the working state evaluation value, the cumulative usage time, the critical cumulative usage time, the voltage fluctuation degree value, the critical voltage fluctuation degree value, the reference vibration frequency, and the allowable deviation vibration frequency remain unchanged and the vibration frequency continuously increases, the closer the vibration frequency is to the reference vibration frequency, the larger the working state evaluation value.

Further, the evaluation value of the dynamic offset degree of the gyroscope is obtained as follows:

$$ξ {I}_{1} = {( \frac{1}{e} )}^{arccot \{ {α}_{7} * [ 1 + {( \frac{ξ {T}_{1}}{ξ {T}_{0}} )}^{2} ] + {α}_{9} * ln ( \frac{ξ {O}_{1}}{ξ {O}_{0}} + 1 ) \}} + {α}_{8} * {log}_{2} ( \frac{ξ {S}_{0}}{ξ {S}_{1}} + 1 )$$

where ξI₁ represents the evaluation value of the dynamic offset degree of the gyroscope, α₇ represents the influence factor of the environmental abnormality evaluation value on the evaluation value of the dynamic offset degree of the gyroscope, α₈ represents the influence factor of the working state evaluation value on the evaluation value of the dynamic offset degree of the gyroscope, α₉ represents the influence factor of the evaluation value of the static offset degree of the gyroscope on the evaluation value of the dynamic offset degree of the gyroscope, ξT₁ represents the environmental abnormality evaluation value, ξT₀ represents the critical environmental abnormality evaluation value, ξS₁ represents the working state evaluation value, ξS₀ represents the critical working state evaluation value, ξO₁ represents the evaluation value of the static offset degree of the gyroscope, and ξO₀ represents the critical evaluation value of the static offset degree of the gyroscope.

α₇, α₈, and α₉ are the preset influence factors of the environmental abnormality evaluation value, the working state evaluation value, and the evaluation value of the static offset degree of the gyroscope on the evaluation value of the dynamic offset degree of the gyroscope in the mouse interaction database, respectively. These influence factors are numerical indicators that measure the influence of the above parameters on the evaluation value of the dynamic offset degree of the gyroscope. Specifically, the environmental abnormality evaluation value, the working state evaluation value, and the evaluation value of the static offset degree of the gyroscope each have a mapping relationship table, which records the corresponding influence factor of each possible parameter value on the evaluation value of the dynamic offset degree of the gyroscope. These mapping relationships can be one-to-one or many-to-one. In practical applications, when evaluating the dynamic offset degree of the gyroscope, the measured environmental abnormality evaluation value, working state evaluation value, and evaluation value of the static offset degree of the gyroscope can be input into their corresponding mapping relationship tables respectively to quickly find the corresponding influence factors of these values on the evaluation value of the dynamic offset degree of the gyroscope. The value range of the influence factor is between 0 and 1

In this embodiment, the environmental abnormality evaluation value, the working state evaluation value, and the evaluation value of the static offset degree of the gyroscope are interrelated in that they jointly affect the dynamic offset degree of the gyroscope: changes in the environmental abnormality and working state may cause effects such as thermal expansion and contraction and electromagnetic interference of the internal components of the gyroscope, thereby increasing its dynamic offset degree; the static offset degree is the error generated by the gyroscope in a stationary state, which is affected by environmental factors (such as temperature changes) and working state (such as power fluctuations). The comprehensively analyzed evaluation value of the dynamic offset degree of the gyroscope can more accurately evaluate the dynamic offset degree of the gyroscope, help to understand the performance of the gyroscope under different working environments and working states, and provide a basis for subsequent error compensation and performance optimization.

Further, the step of judging whether to perform secondary data calibration according to the evaluation value of the dynamic offset degree of the gyroscope includes: obtaining the evaluation threshold of the dynamic offset degree of the gyroscope from the mouse event database; comparing the evaluation value of the dynamic offset degree of the gyroscope with the evaluation threshold of the dynamic offset degree of the gyroscope. If the evaluation value of the dynamic offset degree of the gyroscope is less than or equal to the evaluation threshold of the dynamic offset degree of the gyroscope, secondary data calibration is not performed. If the evaluation value of the dynamic offset degree of the gyroscope is greater than the evaluation threshold of the dynamic offset degree of the gyroscope, secondary data calibration is performed.

In this embodiment, the evaluation threshold of the dynamic offset degree of the gyroscope is a preset value used to judge whether the offset degree of the gyroscope is too large and exceeds the allowable error range. If the offset degree evaluation value is greater than the threshold, it indicates that the current deviation of the gyroscope has exceeded the acceptable range, and the system will start the secondary data calibration process to correct these deviations. For static offset (for example, the deviation of the static rotation angle measured by the gyroscope), the error value can be calculated by comparing the measured static data with the ideal static value (zero value), and then subtracting this deviation value from the actual measurement value in subsequent data processing. If the device is also equipped with an accelerometer, the static data provided by the accelerometer (for example, the acceleration in the direction of gravity) can be used to further calibrate the gyroscope. By combining the data of the accelerometer and the gyroscope, the drift error of the gyroscope can be eliminated or reduced. For dynamic offset (for example, the drift of the gyroscope during movement), a filtering algorithm (such as the Kalman filter) can be used to smooth and correct the output data of the gyroscope and reduce the drift effect. After calibration is completed, the device will regularly update its calibration model to ensure that the real-time corrected data remains within a reasonable error range. Secondary data calibration can significantly improve the measurement accuracy of the gyroscope, especially after long-term use or changes in environmental conditions, and can effectively reduce errors caused by factors such as device aging, temperature changes, and vibrations.

It is a structural schematic diagram of a system for mouse event interaction based on a general gyroscope provided in an embodiment of the present application. The system for mouse event interaction based on a general gyroscope provided in the embodiment of the present application includes: an initial calibration module, a secondary calibration module, an event interaction module, and a mouse event database; wherein the initial calibration module is used to monitor the output data of the gyroscope in a stationary state, process the output data of the gyroscope in a stationary state to obtain an evaluation value of the static offset degree of the gyroscope, collect the output data of the gyroscope, and perform initial data calibration on the output data of the gyroscope according to the evaluation value of the static offset degree of the gyroscope; the secondary calibration module is used to monitor the working environment data and the working state data of the gyroscope, comprehensively analyze the working environment data, the working state data, and the evaluation value of the static offset degree of the gyroscope to obtain an evaluation value of the dynamic offset degree of the gyroscope, and judge whether to perform secondary data calibration according to the evaluation value of the dynamic offset degree of the gyroscope; the event interaction module is used to simulate a mouse event according to the output data of the gyroscope after data calibration is completed.

The embodiment of the present application also provides an electronic device for mouse event interaction based on a general gyroscope, including: a processor, and a memory for storing the executable instructions of the processor; the processor is configured to execute the instructions to enable the electronic device to implement the method for mouse event interaction based on a general gyroscope.

In summary, the embodiment of the present application monitors the output data of the gyroscope in a stationary state, processes the output data of the gyroscope in a stationary state to obtain an evaluation value of the static offset degree of the gyroscope, collects the output data of the gyroscope, performs initial data calibration on the output data of the gyroscope according to the evaluation value of the static offset degree of the gyroscope, monitors the working environment data and the working state data of the gyroscope, comprehensively analyzes the working environment data, the working state data, and the evaluation value of the static offset degree of the gyroscope to obtain an evaluation value of the dynamic offset degree of the gyroscope, judges whether to perform secondary data calibration according to the evaluation value of the dynamic offset degree of the gyroscope, and simulates a mouse event according to the output data of the gyroscope after data calibration is completed, thereby improving the accuracy of gyroscope data.

Those skilled in the art should understand that the embodiments of the present invention can be provided as a method, system, or computer program product. Therefore, the present invention can take the form of an entirely hardware embodiment, an entirely software embodiment, or an embodiment combining software and hardware aspects. Moreover, the present invention can take the form of a computer program product implemented on one or more computer-usable storage media (including but not limited to disk storage, CD-ROM, optical storage, etc.) containing computer-usable program code.

The present invention is described with reference to flowcharts and/or block diagrams of methods, apparatuses (systems), and computer program products according to embodiments of the present invention. It should be understood that each flow and/or block in the flowcharts and/or block diagrams, and combinations of flows and/or blocks in the flowcharts and/or block diagrams can be implemented by computer program instructions. These computer program instructions can be provided to a general-purpose computer, a special-purpose computer, an embedded processor, or other programmable data processing apparatuses to produce a machine, such that the instructions executed by the computer or other programmable data processing apparatuses generate means for implementing the functions specified in one or more flows of the flowcharts and/or one or more blocks of the block diagrams.

These computer program instructions can also be stored in a computer-readable memory that can direct a computer or other programmable data processing apparatuses to function in a particular manner, such that the instructions stored in the computer-readable memory produce an article of manufacture including instruction means that implement the functions specified in one or more flows of the flowcharts and/or one or more blocks of the block diagrams.

These computer program instructions can also be loaded onto a computer or other programmable data processing apparatuses to cause a series of operational steps to be performed on the computer or other programmable apparatuses to produce computer-implemented processing, such that the instructions executed on the computer or other programmable apparatuses provide steps for implementing the functions specified in one or more flows of the flowcharts and/or one or more blocks of the block diagrams.

Although the preferred embodiments of the present invention have been described, those skilled in the art can make additional changes and modifications to these embodiments once they learn the basic inventive concept. Therefore, the appended claims are intended to be construed to include the preferred embodiments and all changes and modifications that fall within the scope of the present invention.

Obviously, those skilled in the art can make various modifications and variations to the present invention without departing from the spirit and scope of the present invention. Thus, if these modifications and variations of the present invention fall within the scope of the appended claims and their equivalent technologies, the present invention is also intended to include these modifications and variations.

1. A method for mouse event interaction based on a general gyroscope, comprising the steps of:
monitoring the output data of the gyroscope in a stationary state and processing said output data to obtain an evaluation value of the static offset degree of the gyroscope;
collecting the output data of the gyroscope and performing an initial data calibration on said output data based on the evaluation value of the static offset degree of the gyroscope;
monitoring the working environment data and the working state data of the gyroscope, comprehensively analyzing said working environment data, said working state data, and the evaluation value of the static offset degree of the gyroscope to obtain an evaluation value of the dynamic offset degree of the gyroscope, and determining whether to perform a secondary data calibration based on said evaluation value of the dynamic offset degree of the gyroscope;
simulating a mouse event based on the output data of the gyroscope after the data calibration is completed.

2. The method for mouse event interaction based on a general gyroscope according to claim 1, wherein the step of processing the output data of the gyroscope in a stationary state to obtain an evaluation value of the static offset degree of the gyroscope comprises:
the output data of the gyroscope in a stationary state includes the angular velocity and angular acceleration around the X, Y, and Z axes, wherein the angular velocity includes an angular velocity offset value and an angular velocity fluctuation degree value;
obtaining a critical angular velocity offset value, a critical angular velocity fluctuation degree value, a reference angular acceleration, and an allowable deviation angular acceleration from a mouse interaction database;
comprehensively analyzing to obtain the evaluation value of the static offset degree of the gyroscope.

3. The method for mouse event interaction based on a general gyroscope according to claim 1, wherein the step of performing an initial data calibration on the output data of the gyroscope based on the evaluation value of the static offset degree of the gyroscope comprises:
obtaining a first evaluation threshold of the static offset degree of the gyroscope and a second evaluation threshold of the static offset degree of the gyroscope from a mouse event database;
comparing the evaluation value of the static offset degree of the gyroscope with the first evaluation threshold of the static offset degree of the gyroscope and the second evaluation threshold of the static offset degree of the gyroscope respectively, and if the evaluation value of the static offset degree of the gyroscope is less than or equal to the first evaluation threshold of the static offset degree of the gyroscope, marking the gyroscope as a low-offset gyroscope, if the evaluation value of the static offset degree of the gyroscope is greater than the first evaluation threshold of the static offset degree of the gyroscope and less than or equal to the second evaluation threshold of the static offset degree of the gyroscope, marking the gyroscope as a medium-offset gyroscope, if the evaluation value of the static offset degree of the gyroscope is greater than the second evaluation threshold of the static offset degree of the gyroscope, marking the gyroscope as a high-offset gyroscope;
performing an initial data calibration on the output data of the gyroscope based on an output data correction value corresponding to a gyroscope offset level preset in the mouse event database.

4. The method for mouse event interaction based on a general gyroscope according to claim 1, wherein the step of comprehensively analyzing the working environment data, the working state data, and the evaluation value of the static offset degree of the gyroscope to obtain an evaluation value of the dynamic offset degree of the gyroscope comprises:
comprehensively analyzing the working environment data of the gyroscope to obtain an environmental abnormality evaluation value;
comprehensively analyzing the working state data of the gyroscope to obtain a working state evaluation value;
obtaining a critical environmental abnormality evaluation value, a critical working state evaluation value, and a critical evaluation value of the static offset degree of the gyroscope from a mouse event database;
comprehensively analyzing to obtain the evaluation value of the dynamic offset degree of the gyroscope.

5. The method for mouse event interaction based on a general gyroscope according to claim 4, wherein the step of comprehensively analyzing the working environment data of the gyroscope to obtain an environmental abnormality evaluation value comprises:
the working environment data of the gyroscope includes the temperature at each time monitoring point, the temperature change rate at each time monitoring point, and the maximum temperature difference;
obtaining a reference temperature, an allowable deviation temperature, a critical temperature change rate, and a critical maximum temperature difference from a mouse event database;
comprehensively analyzing to obtain the environmental abnormality evaluation value.

6. The method for mouse event interaction based on a general gyroscope according to claim 4, wherein the step of comprehensively analyzing the working state data of the gyroscope to obtain a working state evaluation value comprises:
the working state data of the gyroscope includes the cumulative usage time, the voltage fluctuation degree value, and the vibration frequency;
obtaining a critical cumulative usage time, a critical voltage fluctuation degree value, a reference vibration frequency, and an allowable deviation vibration frequency from a mouse event database;
comprehensively analyzing to obtain the working state evaluation value.

7. The method for mouse event interaction based on a general gyroscope according to claim 4, wherein the evaluation value of the dynamic offset degree of the gyroscope is obtained as follows:
$$ξ {I}_{1} = {( \frac{1}{e} )}^{arccot \{ {α}_{7} * [ 1 + {( \frac{ξ {T}_{1}}{ξ {T}_{0}} )}^{2} ] + {α}_{9} * ln ( \frac{ξ {O}_{1}}{ξ {O}_{0}} + 1 ) \}} + {α}_{8} * {log}_{2} ( \frac{ξ {S}_{0}}{ξ {S}_{1}} + 1 )$$
where ξI₁ represents the evaluation value of the dynamic offset degree of the gyroscope, α₇ represents an influence factor of the environmental abnormality evaluation value on the evaluation value of the dynamic offset degree of the gyroscope, α₈ represents an influence factor of the working state evaluation value on the evaluation value of the dynamic offset degree of the gyroscope, α₉ represents an influence factor of the evaluation value of the static offset degree of the gyroscope on the evaluation value of the dynamic offset degree of the gyroscope, ξT₁ represents the environmental abnormality evaluation value, ξT₀ represents a critical environmental abnormality evaluation value, ξS₁ represents the working state evaluation value, ξS₀ represents a critical working state evaluation value, ξO₁ represents the evaluation value of the static offset degree of the gyroscope, and ξO₀ represents a critical evaluation value of the static offset degree of the gyroscope.

8. The method for mouse event interaction based on a general gyroscope according to claim 1, wherein the step of determining whether to perform a secondary data calibration based on the evaluation value of the dynamic offset degree of the gyroscope comprises:
obtaining an evaluation threshold of the dynamic offset degree of the gyroscope from a mouse event database;
comparing the evaluation value of the dynamic offset degree of the gyroscope with the evaluation threshold of the dynamic offset degree of the gyroscope; if the evaluation value of the dynamic offset degree of the gyroscope is less than or equal to the evaluation threshold of the dynamic offset degree of the gyroscope, not performing the secondary data calibration; and if the evaluation value of the dynamic offset degree of the gyroscope is greater than the evaluation threshold of the dynamic offset degree of the gyroscope, performing the secondary data calibration.

9. A system for mouse event interaction based on a general gyroscope, applying the method for mouse event interaction based on a general gyroscope according to claim 1, comprising an initial calibration module, a secondary calibration module, an event interaction module, and a mouse event database; wherein the initial calibration module is used for monitoring the output data of the gyroscope in a stationary state, processing said output data to obtain an evaluation value of the static offset degree of the gyroscope, collecting the output data of the gyroscope, and performing an initial data calibration on said output data based on the evaluation value of the static offset degree of the gyroscope; the secondary calibration module is used for monitoring the working environment data and the working state data of the gyroscope, comprehensively analyzing said working environment data, said working state data, and the evaluation value of the static offset degree of the gyroscope to obtain an evaluation value of the dynamic offset degree of the gyroscope, and determining whether to perform a secondary data calibration based on said evaluation value of the dynamic offset degree of the gyroscope; the event interaction module is used for simulating a mouse event based on the output data of the gyroscope after the data calibration is completed.

10. An electronic device for mouse event interaction based on a general gyroscope, comprising: a processor and a memory for storing executable instructions of the processor; the processor is configured to execute said instructions to enable the electronic device to implement the method for mouse event interaction based on a general gyroscope according to claim 1.
